(19) United States
(12) Patent Application Publication
(10) Pub. No.: US 2006/0124171 A1
(43) Pub. Date: Jun. 15, 2006

(54) Secure wireless leak detection system

(76) Inventors: John D. Ghazarian, Henderson, NV (US); Ammon N. Balaster, Boulder, CO (US); Tom Ruggieri, Santa Ana, CA (US)

Correspondence Address: JOHN D. GHAZARIAN, 2575 W. HORIZON RIDGE PKWY, #1611, HENDERSON, NV, 89052, US

(21) Appl. No.: 11/158,953

(22) Filed: Jun. 22, 2005

Related U.S. Application Data
(60) Provisional application No. 60/635,805, filed on Dec. 14, 2004.

(51) Int. Cl. F16K 23/00

(52) U.S. Cl. 137/312

(57) ABSTRACT

A method utilizing a wireless leak detection and prevention system, used for preventing property damage and personal injury caused by liquid or gas leak. The system comprised of a wireless, battery operated apparatus having sensor(s) incorporated with an RF transmitter, used for detecting liquid or gas leaks, and transmits signal(s) to a wireless valve shutoff control unit. The valve shutoff control unit containing an RF transceiver and a processor designed to receive the detected signals and activate a supervised solenoid or motorized valve shut-off mechanism to stop the detected leak. In a preferred embodiment of the invention, the wireless valve control unit is connected to a motor, which is mounted on manual shutoff valve. Wherein the valve control unit activates the motor to produce torque to turn the valve towards a close position in response to a received detected leak signal from a sensor. An electronic or electromechanical circuitry is provided, to detect motor or gear turn cycles. The motor rotation is being controlled by the valve control unit processor, which stops motor rotation in response to a detected preset number of motor turn cycles. A digital, voice, SMS text message phone dialer is add to dispatch the detected leak signals, and notify monitoring personnel of the supervised system operation status. And provide user access to turn on or off a valve(s) from a remote location.

### BACKGROUND OF INVENTION

In the past many different methods and devices have been used to detect liquid or gas leaks. Although the prior art teachings are found to be useful, in general most of prior art utilized different methods to detect leak and shutoff a solenoid or a motorized valve to stop detected leaks. The teachings found in prior arts are not able to provide adequate methods to secure the positive operation leak detection and prevention, in particular teachings found in prior arts fail to provide fully supervised leak detection and damage control system, which ascertains system operation in accordance with the embodiment of the invention.

One such example U.S. Pat. 5,655,561 to Wendel et al, teaches a method using a wireless leak detection, which provides a visible and audible alarm indication, including a buzzer and a user programmable digital voice circuit for identifying the area in which a flood occurs.

U.S. Pat. No. 6,310,555 to Stem, describes a system for detection of presence of airborne water leak in microscopic amounts, using a flexible sensor pad with an outer and inner ring copper coils, and a electronic circuit designed to respond to the presence of microscopic size water droplets, and alerting system with an audible and visible alarm.

U.S. Pat. No. 6,639,517 to Chapman et al. where illustrates a water leak detection mat, having one or more electrodes arranged in pattern around the upper surface of the base mat, such as the two wires of each pair are parallel to the other.

U.S. Pat. No. 6,662,821 B2 to Jacobsen et al. teaches a method for detecting leak and operating an existing valve shutoff, in response to detected leak, using a motor attached to a valve via a coupler. The motor being controlled to stop turning the valve in response to the amount of current generated when torque exceeds a predetermined value, thereby closing the valve and terminating current supplied to the motor.

U.S. Pat. No. 6,880,806 B2 to Haikawa et al. wherein a valve gear includes a valve which controls flow rate of fluid and operation of which is determined according to rotation position of a valve element, using an actuator for providing a rotation force to a rotary valve shaft that changes the opening of the valve, and attaching/detaching means includes a locking element formed at its prescribed position which engaging element concave/convex portion, to prevent actuator from coming off the valve.

Perhaps the teaching found in U.S. Pat. No. 6,662,821 B2 to Jacobsen et al. is useful and represents a significant improvement in the art, but it has it's limitation to provide secure valve shut-off mechanism, by mainly relying on measuring when the motor current exceeds a predetermined current value, to determine valve closure. One can presume if Jacobson et al. system was used on a rusted or frozen valve, the motor would not be able to turn the valve to its fully closed position. In this example; Jacobson at al. electronic circuitry will measure the limit of the predetermined current value; and therefore stop the current flow to the motor. The valve will thus remain open, which then fails to stop the leak and prevent property damage, or cause bodily injury or even human life loss, in such event where there is a gas leak. Also, if a phone dialer was used it would have provided misleading information to the monitoring station.

It is accordingly the primary objective of the present invention to provide a leak detection and damage control system, which uses a fully supervised valve shutoff mechanism which ascertains complete closure of a particular valve, by utilizing a valve shutoff control unit that monitors a successful solenoid or motorized valve closure, and notifies the user or maintenance personnel to the detection of a leak and corresponding condition. In the event that the valve shutoff mechanism fails to close a particular valve, due to the presence of a corroded or frozen valve, and or a defective solenoid or valve motor, the system sounds an alarm and notifies the user or maintenance personnel to the system fail condition, through a phone auto dialer, Internet, or by wireless means

It is another objective of the present invention that utilizes a valve control unit that performs at predetermined periodic times, a solenoid or motorized valve closure/open test procedure, to verify the system successful operation, and to maintain an operative condition of the valve and mechanism. In an event a system operation failure is detected, the system generates an alarm signal and notifies the user or maintenance personnel through a phone auto dialer or by wireless means.

It is a further objective of the present invention that provides a low power A/C or fully battery operated water leak detection and valve control shutoff system, which can be installed in remote locations and operated for long periods of time; where no A/C power is available. It also provides a battery operated cellular or wireless communication means to notify leak detection and successful (or failed) valve closure information to a monitoring station.

It is also an objective of the present invention to provide a valve shut-off mechanism, mounting, and valve adaptor alignment means that can be easily installed on existing valves thus eliminating the need to perform any plumbing or pipe fitting operation.

### SUMMARY OF INVENTION

A method utilizing a secure wireless leak detection and prevention system, used for the prevention of property damage and bodily injury or human life loss.

The system comprised of a wireless battery operated apparatus having liquid or gas detection sensor(s) incorporated with an RF transmitter, used for detecting liquid or gas leaks, and transmit (for 12 seconds) said detection signal(s) at preset time intervals to a valve shutoff control receiver or transceiver unit. The detection apparatus of the present invention is commonly installed at remote locations where liquid or gas pipes are present and where appliances are located.

An A/C or battery operated valve control RF receiver or a transceiver unit is used, to receive leak detection signal(s) from said RF wireless leak detection apparatus, and an onboard processor is used to control the operation of a liquid or gas pipe shutoff valve mechanism which may be plumbed into the pipe line or may be installed on an existing shut-off valve without requiring any plumbing or pipe-fitting operation.

It is a primary objective of the present invention utilizing a valve control receiver or transceiver unit that operates on A/C or battery power. If a battery is used as the primary source of power, the battery life expectancy is 3 to 4 years, due to the low current consumption method used in the present invention. The low power consumption is achieved by setting the processor in sleep mode; and power up (Wake up) for approximately 0.5 second every 12 second to receive RF signals from a leak detection transmitter unit(s). This then provides coordinated timed RF communication between the wireless leak detection unit(s) and wireless valve control receiver unit, to minimize valve control receiver unit battery consumption. This provides a method for leak detection and prevention that can operate with A/C and or battery for extended periods of time and is completely wireless. If A/C power is available, battery operation may still be functional as backup in case of A/C power failure. The A/C power maintains a continuous charge of the battery when available.

If and when the valve control unit, receives an RF leak detection signal from a leak detection sensor unit, the valve control unit processor sends a pulse signal to latch a relay, which then activates a closure detecting solenoid valve to shut the valve and stop the leak. If solenoid valve closed successfully, the valve closure detection switch closes and send a signal to valve control unit processor indicating successful valve shutoff. The processor then enters into sleep mode to save battery, until a reset command is given to operate in stand by mode again.

The valve control unit of the present invention is capable of indicating both leak detection, inoperative valve (stuck valve) and valve control unit low battery condition by a visual or audible alarm, and transmit said leak detection, inoperative valve and low battery conditions signals to a monitoring station via phone auto-dialer, wireless RF transceiver, or send a text message to mobile phones by wireless means.

The present invention monitoring station is equipped with a wireless or a phone line connected computer interface unit, which is able to receive signals from remote location phone dialers or wireless transceiver units. The computer interface unit upon receipt of said signals provides visual information and audible alarm when a leak signal is received. It also provides a means to transmit commands to reset, open or close the valve or program and control operational functions of a phone dialer or a wireless transceiver unit.

In a preferred embodiment of the invention, said valve control receiver/transceiver unit is connected to a motor, which is securely mounted on manual shutoff valve. Wherein said valve control unit activates the motor to produce torque to turn the valve towards a close position in response to receiving a detected leak signal. An electronic circuit is provided within said valve control unit, to monitor the shut-off valve motor or gear turn cycles, or to otherwise detect the operation of a limit switch or sense mechanism on the valve to indicate a complete valve closure. The motor or actuator being controlled by a processor to stop turning the valve in response to the detected number of motor turn cycle or limit sense indicator which corresponds to complete valve closure, and further by detecting the subsequent rise in current that occurs when torque exceeds a predetermined value; this then provides a positive indication of a successful valve shutoff process. The processor and receiver resume operation on reset command.

In the event the shutoff valve motor or actuator can not complete the needed preset cycle of motor or gear turns, or it does not receive the closure limit sense signal, due to a defective or corroded manual valve or actuator mechanism, the valve control unit produces an alarm signal and or transmits an RF signal containing information of a particular shutoff valve closure failure to a monitoring station, through a phone dialer or through a wireless means.

To further assure the performance of the present invention, the present art is capable of periodically operating a valve shutoff and open test. In such a test mode, if the valve control unit motor does not turn the necessary cycles to shutoff the manual valve, the valve control unit produces an alarm signal or sends a manual valve mechanism failed signal to a monitoring station through a phone auto dialer device, or by wireless means.

The present invention provides a fully wireless battery operated/battery backup leak detection and leak prevention system, which is easy to install with self aligning valve adaptors (do it yourself installation) there is no need of running wires, plumbing, cutting, or fitting pipes, or worry about creating electrical hazard. No need for building inspector, or professional electrician and or a plumber. The valve control unit of the present invention may be used in indoor and outdoor applications.

### BRIEF DESCRIPTION OF THE DRAWINGS

FIG. 1. illustrates leak detection sensor/transmitting unit. And the view of receiving valve control unit, connected to a supervised motor valve mounted within a pipe.

FIG. 2. illustrates a perspective view of receiving valve control unit incorporated with a supervised motor mechanism circuitry, a battery, self-aligning valve handle adapter, and universal coupler mounted on an existing manual valve.

FIG. 2.B illustrates supervised motor circuitry, utilizing a U joint coupler mounted on existing manual valve.

FIG. 3. illustrates a gate/globe valve handle adaptor embodiment, a direct valve shaft adaptor, and a gas ball valve handle adaptor embodiment

FIG. 4. illustrates the receiving valve control unit connected to a supervised solenoid valve shutoff device, using valve- shutoff detection sensor.

FIG. 5. illustrates the view of a phone auto dialer, or a wireless communication apparatus.

FIG. 6. is a block diagram of a supervised valve control unit, in accordance with the embodiment of the invention.

### DETAILED DESCRIPTION OF THE INVENTION

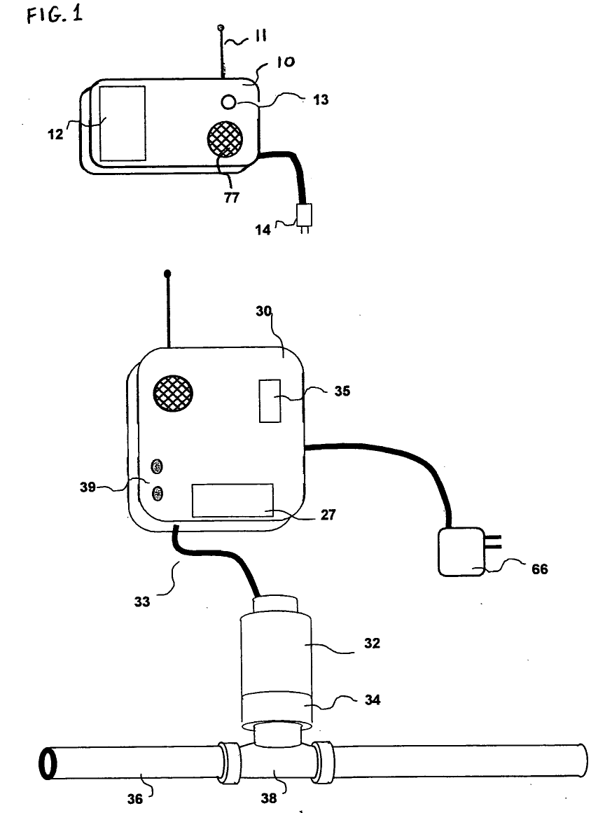

The principles of the invention are described mainly in reference to a transmitter device unit capable of detecting the presence of any detected substance, as illustrated in: FIG. 1. A wireless leak detection unit 10 using a battery 12 as power supply, equipped with a leak detection sensor 14 used to detect a variety of substances, such as water, gas, petroleum, etc. and a built-in transmitter used to transmit the detected signals by use of an antenna 11. The leak detection unit is primarily installed in buildings, homes, factories, in open field applications such as irrigation plants, petroleum plants and pipelines, etc. where there is high possibility for pipes and fittings to leak.

As illustrated, when a leak sensor unit 14 detects a leak, the transmitter transmits through antenna 11, a unique coded signal containing information of said leak detection unit 10, and an onboard LED 13 flashes to indicate unit leak detection and successful wireless transmission.

Wherein a valve control unit 30 is in a housing. Utilizing A/C 66 or battery 27 as power supply, having a processor 35 which is used in a setup process to memorize (learn) said motor 32 or gear 34 turn cycle pulse count required to close the valve that the motor 32 and gear 34 is attached to. The valve control unit 30 is connected to the supervised motorized valve 38 by a cable 33, the cable is used to provide power to the motor 32 and pass through motor rotation or gear count pulse signals to valve control unit processor 35. The motor 32, counter 34 and shutoff valve 38 are incorporated, and it is installed within a pipe 36.

The valve control unit processor upon receipt of detected leak signal, turns on the motor 32 to close the valve 38, and the processor 35 stops the motor 32 rotation based on received motor cycle pulse or gear counter 34 signal. And the LED 39 turns Red indicating the valve 38 is closed. Further embodiment describes the details of use of the art.

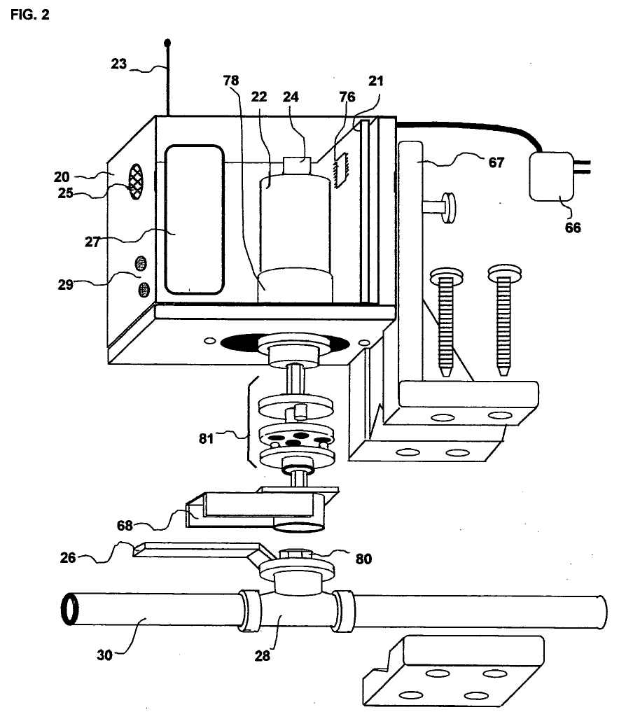

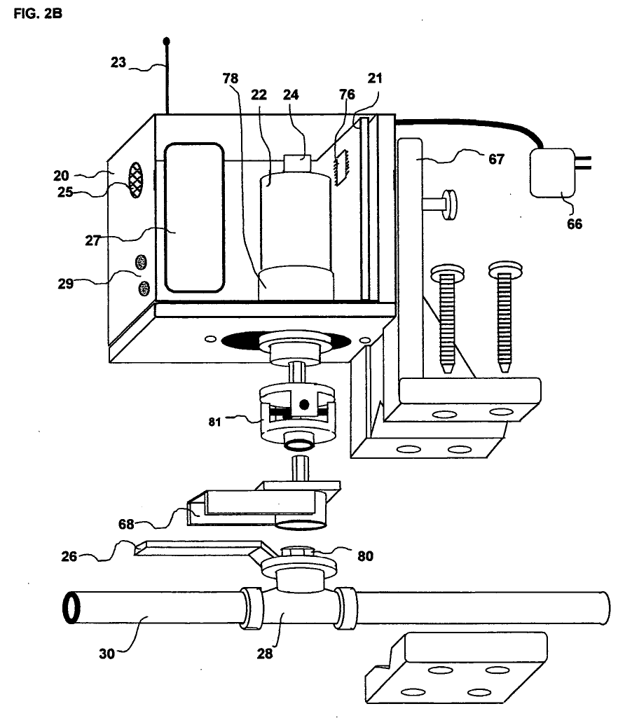

FIG. 2. describes further embodiment and the details of a supervised valve shutoff system, wherein a control unit 20 housing, mounted on an adjustable bracket 67, used to mount the valve control unit securely on a valve 28 or pipe 36, and the control unit is attached to the manual valve by use of a valve shaft connection system or self-aligning valve handle adaptor 68. The valve control unit is powered by a battery 27 or by an A/C power supply 66. A motor 22 is incorporated to open and close the manual valve 28 by application of torque to valve shaft or handle 26. The motor 22 and or gear 78 contains an optical, magnetic, or an electromechanical circuit 24 to detect motor or gear turn cycles. A processor 76 is used in a setup process to memorize (learn) said motor 22 or gear 78 turn cycle pulse count required to close the valve that the motor 22 and gear 78 is attached to. And a transceiver 21 is incorporated to receive signals from a leak detection unit.

When the valve control unit 20 transceiver 21 receives a leak detection transmitted signal through the antenna 23, the transceiver 21 sends a signal to the valve control unit processor 76. The processor 76 upon receipt of said signal, activates a relay which turns on the motor 22. The processor 76, during motor 22 turn cycle, monitors motor generated pulse signals or gear counts, when the detected number of pulses match the learned number found in processor 76 memory, the processor turns off the motor 22, which completes the manual valve 28 closure. And red LED 29 blinks indicating the valve is shut.

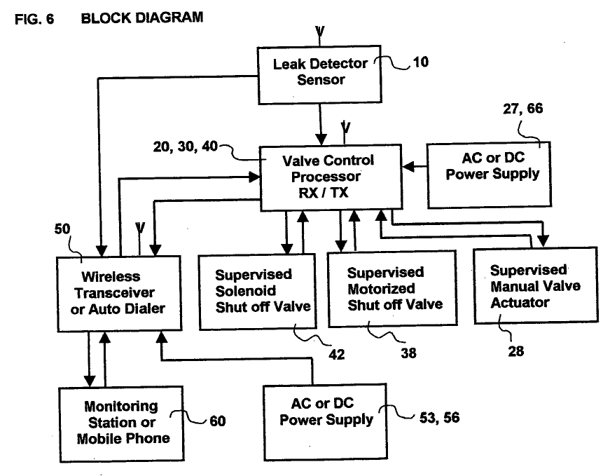

In the event the valve control unit processor 76 during valve 28 closure procedure, does not detect motor or gear rotation pulse signals, or detects certain motor rotation pulse, which total less then that of pre-programmed needed number of pulses to completely close the valve 28 in a predetermined length of time, due to a corroded or frozen valve 28, blocked valve handle 26 or a defective motor 22, or gear 78, the valve control unit beeper 25 generates an audible alarm and the transceiver 21 will transmit an alarm condition signal to a monitoring station (FIG. 6, 60). Or if the processor detects far more motor turn pulses than required number needed, due to a broken valve shaft, motor and or gear, the valve control unit generates similar alarm conditions.

In addition the secure wireless leak detection system of the present invention, provides a valve control unit processor which is programmed to periodically conduct a valve closure and open test/exercise procedure to ascertain and maintain system operation, and to notify the user if the shutoff valve fails to rotate the needed number of turns to completely close the valve or to open the valve.

To aid in alignment or to avoid any possible torque binding in the event of a misalignment, a universal coupler mechanism 81 is used to transmit the torque between the motor shaft and the valve handle adaptor 68. The universal coupler 81 allows for substantial misalignment of the motor shaft and the valve shaft as the torque is transmitted through to the valve shaft. Or a U joint coupler 81 (FIG. 2B) mechanism is used.

For ease of installation and to further aid in alignment and avoid any possible binding, the valve handle adaptor 68 incorporates a centering and torque reaction feature whereby the center hub of the adaptor 68 fits snuggly over the existing manual valve shaft nut 80 to align and center the adaptor 68 onto the manual handle 26 and to accommodate the torque reaction of motor gear 78 and valve handle adaptor 68 against the manual valve handle 26

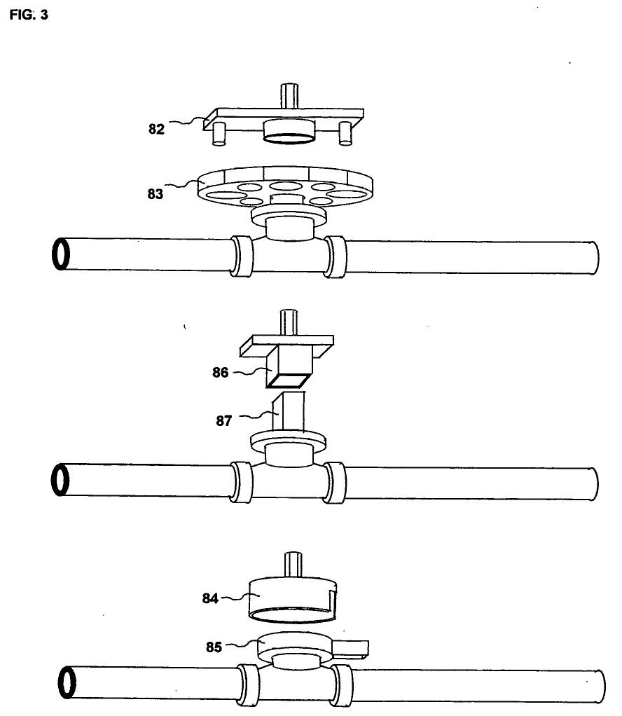

FIG. 3 shows a similar example of a gate or globe valve handle 82 and a gas ball valve handle 85 with corresponding valve handle adaptors 82 and 84. In another embodiment, if the handle of the manual valve is removed a valve shaft adapter 86 is used to mate directly with the various configurations of valve shaft stem 87.

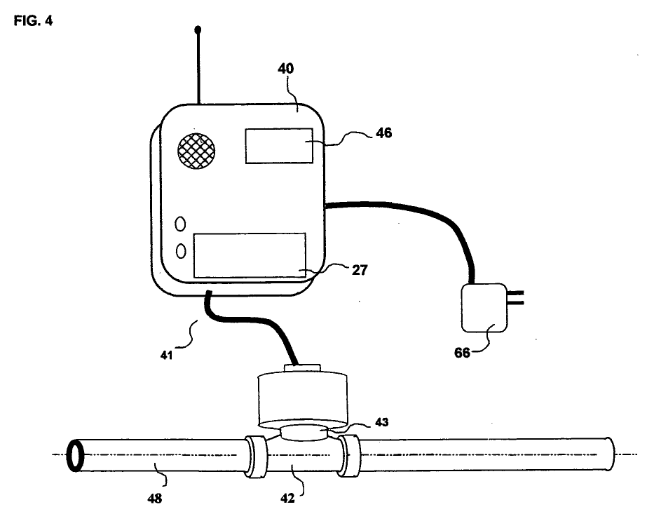

FIG. 4. describes a fully supervised valve control unit 40, in a housing, and it is connected to a supervised solenoid shut-off valve assembly 42, installed within a pipe 48. to shut said valve when leak is detected. Said valve control unit is connected to said solenoid valve by the use of a cable 41 to provide power and receive the valve closure supervisory signals. The supervised solenoid valve contains a valve closure detection sensor 43, which is used to detect solenoid valve 42 closures, and transmit the detected signal to the valve control unit processor 46 to confirm successful solenoid valve closure 42.

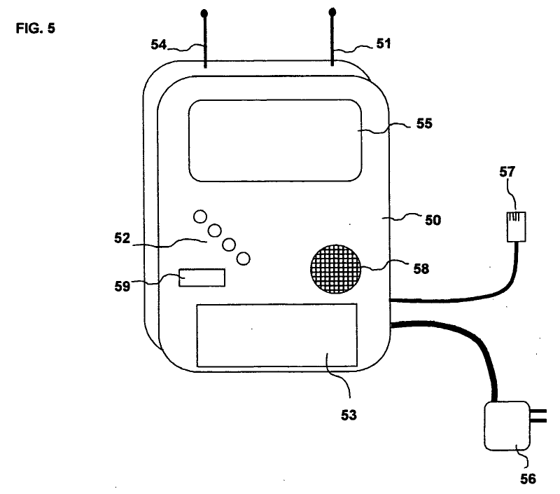

FIG. 5. describes a phone dialer 50, powered by an A/C source 56 or a preferred embodiment uses battery 53 as the power supply, especially if it's used in remote locations, where no A/C 56 power is available. In order to save energy and provide long term battery life expectancy, the battery 53 circuitry powers on the auto dialer receiver circuitry at time interval duty cycle to conserve energy keeping the transceiver in power on mode for only a short period of time to receive a transmitted leak detection signal from a leak detection sensor unit. The auto dialer unit 50 contains a processor 59 pre-programmed with a unique code, to identify said auto dialer 50. A transceiver with antenna 51 is used to receive leak detection signals from leak detection unit(s), and the processor 59 is used to identify said leak detection unit and display the detected leak detection unit ID information on the LCD screen 55, produce a visual 52 and audible 58 alarm signal, and send both said leak detection unit ID information and said auto dialer ID information through land phone line 57, cellular, satellite or by wireless means 54 to a monitoring station.

FIG. 6 is a block diagram of the system. In a preferred embodiment of the invention, the leak detection unit used in the present invention contains a transceiver, and said valve control unit and or said phone auto dialer or wireless auto dialer 50 is capable at preset time interval to establish a supervisory communication to verify proper operation of the leak detection unit 10. In the event said valve control unit 20, 30 or 40; or phone auto dialer unit 50 detects operational failure with a particular leak detection sensor 10, said valve control unit 20,30, 40 or phone auto dialer unit 50 transmit a signal to the particular leak detection sensor unit 10, and leak detection unit beeper 77 produces an alarm to signal personnel of unit failure. In addition the phone auto dialer 50 notifies failed sensor 10 information to a monitoring station 60.

Also said phone auto dialer 50 can receive commands from users in remote locations by phone, or RF communication and subsequently transmit wirelessly said received commands to the valve control unit 20, 30, and or 40 to close or open said valve 42, 38, 28 as requested.

What is claimed:

1. A method utilizing a supervised leak detection and prevention system, comprised of a battery operated supervised wireless leak detection unit, which contains; a leak detection sensor connected to the transceiver, which is capable of transmitting a unique coded signal in response to a detected leak.
An A/C or battery operated supervised wireless valve control transceiver unit comprised of
a receiver capable of receiving said unique coded transmitted signal, and send corresponding signal to a processor.
a motorized shutoff valve having a motor which contains rotation pulse or gear turn counter, used for providing a supervised valve closure. Said motorized valve is installed within a pipe.
The motor being connected to the valve control receiving unit, wherein the valve control unit contains a processor which is used in a setup process to memorize (learn) said motor pulse or gear turn count required to close the valve that the motor and gear is connected to.
Said valve control unit processor upon receipt of said leak detection signal, turns on the motor to generate torque to close the valve, the motor being controlled to stop turning the valve in response to processor receiving prescribed number of motor rotation pulse, or gear counter signal and transmit a coded signal indicating successful or failed valve closure.

2. A method utilizing a supervised leak detection and prevention system, wherein an A/C or battery operated wireless valve control unit housing, mounted on an adjustable bracket, used to mount the valve control unit securely on a pipe or manual valve, and the control unit motor is attached to the manual valve by use of valve system handle adaptor or valve shaft adaptor.
A motor is incorporated to open and close the manual valve. Said motor, gear and or shaft contains an optical, magnetic, or an electromechanical circuit to detect motor or gear turn cycles to provide supervisory valve closure operation.
A processor is used, in a setup process to memorize (learn) said motor or gear turn cycle pulse count required to close the valve that the motor and gear is attached to. And a transceiver is incorporated to receive signals from a leak detection unit.
When the valve control unit transceiver receives a leak detection transmitted signal from a leak detection sensor, the transceiver sends corresponding signal to the valve control unit processor. The processor upon receipt of said signal, turns on the motor to generate torque to close the valve, the motor being controlled to stop turning the valve in response to processor received number of motor rotation pulse, gear counter signal and transmit a coded signal indicating successful or failed valve closure.

3. Method utilizing a supervised leak detection and a prevention system as claimed in claims 1 and 2, wherein said system control unit processor receives motor rotation pulse or gear counter signals during valve closure procedure. If, within a predetermined period of time, said processor does not detect motor rotation pulse signals, or detects certain motor rotation pulse, which totals less than that of pre-programmed needed number of pulses required to completely close the valve due to a corroded valve, a frozen valve, block valve handle or a defective motor or gear, the valve control unit generates an audio and or a visual alarm, and or the transceiver will transmit an alarm condition signal to a monitoring station through phone auto dialer controller or by wireless means. Or if the processor detects more motor turn pulses than required number needed, due to a broken valve shaft or gear, the valve control unit generates similar alarm conditions.

4. A method utilizing a supervised leak detection and prevention system as claimed in claims 1 and 2, additionally provides a valve control unit processor, which is programmed to periodically conduct a valve “closure” and “open” test/exercise procedure to ascertain and maintain system operation, and to notify user if the valve shutoff motor fails to rotate the needed number of turns to completely close the valve or to open the valve.

5. A method utilizing a supervised leak detection and prevention system as claimed in claim 2 wherein the valve handle adaptor incorporates a centering and torque reaction feature, whereby the center tube or hub of the adaptor fits over the existing valve handle shaft nut of a manual valve and, in the case of a gas ball valve, to align and center the adaptor over the manual handle or hub, as a means to eliminate misalignment and possible binding of the mechanical turning connection by receiving the torque reaction of the motor gear and valve handle adaptor against the valve handle as required to reliably turn the valve shaft.

6. A method utilizing a supervised leak detection and prevention system as claimed in claim 2, wherein a universal coupler or a U joint is utilized for alignment or to avoid any possible binding in the event of a misalignment. The universal coupler mechanism transmits the torque between the motor shaft and the valve handle adaptor, the universal coupler having the ability to allow for substantial misalignment of the motor shaft and the valve shaft. Or a U joint coupler mechanism is used to further overcome valve control motor mounting misalignment to avoid possible binding.

7. A method utilizing a supervised leak detection and prevention system, wherein a fully supervised wireless valve control unit, is connected to a supervised solenoid shutoff valve assembly installed within a pipe. The valve control unit generates needed energy to close said supervised solenoid valve, in response to received leak detection signal from a leak detection sensor. The supervised solenoid valve contains a valve closure detection sensor, which is used to detect successful solenoid valve closures, and transmit the detected valve closure signal, to the valve control unit processor, to indicate successful or failed solenoid valve closure.

8. A method utilizing a supervised leak detection and prevention system as claimed in claims 1, 2, and 7, wherein an additional A/C or battery operated supervisory phone auto dialer is used to accommodate supervisory use of the system. The auto dialer unit contains a processor pre-programmed with a unique code, to identify said auto dialer. A transceiver with antenna is used to receive leak detection signals from leak detection unit(s), and the processor is used to identify said leak detection unit and display the detected leak detection unit ID information on said dialer display screen, and or produce a visual and audible alarm signal, and send both said leak detection unit ID information and said auto dialer ID information through land phone line, cellular, satellite, PC/Internet or by wireless means to a monitoring station.

9. A method utilizing a supervised leak detection and prevention system as claimed in claims 1, 2, 7 and 8, wherein the leak detection sensor unit contains a transceiver, said valve control unit and or said phone auto dialer or by wireless means, is capable at preset time interval to establish a supervisory communication to verify proper operation of the leak detection sensor unit.
In the event said valve control unit, or phone auto dialer unit detects operational failure with a particular leak detection sensor, said valve control unit or phone auto dialer unit transmit a signal to the particular leak detection sensor unit, and the leak detection unit produces an audio and or a visual alarm to notify user or personnel of the detection unit failure. Or said phone dialer controller displays said failed leak detection unit ID information, and or transmit a signal containing information to said particular failed leak detection unit and or to the particular phone dialer information to a monitoring station.

10. A method utilizing a supervised leak detection and prevention system as claimed in claim 9, wherein said phone auto dialer or said wireless communication means, can receive commands from a user phone or PC/Internet or transmitter located at a remote location, which subsequently transmits wirelessly said received commands to the valve control unit to close or open said valve as requested.

11. A method utilizing a supervised leak detection and prevention system as claimed in claim 1, 2, 7, and 8, wherein as preferred embodiment utilizes a battery as the power supply, used in particularly at remote location, by utilizing an energy saving circuitry, which powers on the valve control or auto dialer receiver circuitry at time interval duty cycle, to conserve energy keeping the transceiver in power “ON” mode for only a short period of time, to receive a transmitted leak detection signal from a leak detection sensor unit.

12. A method utilizing a supervised leak detection and prevention system, as claimed in claim 8 and 9, wherein said phone auto dialer, wireless cellular dialer, satellite phone, PC/Internet, and wireless means transmitted signal, leak detection, supervisory valve closure, or periodic supervisory test procedure result; is provided to a monitoring station by means of digital data, a prerecorded playback voice message, and or by a text message.
